(19) United States
(12) Patent Application Publication
(10) Pub. No.: US 2021/0281110 A1
(43) Pub. Date: Sep. 9, 2021

(54) WIRELESS CHARGING PAD

(71) Applicants: DEXIN ELECTRONIC LTD., Dongguan (CN); DEXIN CORPORATION, New Taipei City (TW)

(72) Inventors: HO-LUNG LU, NEW TAIPEI CITY (TW); HSIU-HSUAN LIN, Taipei City (TW)

(21) Appl. No.: 16/929,114

(22) Filed: Jul. 15, 2020

(30) Foreign Application Priority Data
Mar. 6, 2020 (TW) 109107449

(51) Int. Cl. H02J 50/12; H02J 7/00; G06F 3/039; G06F 3/038

(52) U.S. Cl. CPC H02J 50/12; H02J 7/0042; G06F 2203/0384; G06F 3/038; G06F 3/0395

(57) ABSTRACT

A wireless charging pad including a substrate, a circuit board, a coil module, and a colloid is provided. The circuit board and the coil module are disposed on the substrate. The circuit board includes a control circuit and a voltage conversion circuit. The control circuit is electrically connected to the voltage conversion circuit and the coil module is electrically connected to the voltage conversion circuit. A colloid encapsulates the substrate, the circuit board, and the coil module, and the colloid has a flat appearance.

### CROSS-REFERENCE TO RELATED PATENT APPLICATION

This application claims the benefit of priority to Taiwan Patent Application No. 109107449, filed on Mar. 6, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a charging pad, and more particularly to a wireless charging pad.

### BACKGROUND OF THE DISCLOSURE

In recent years, with the standardization of wireless charging technology, many companies have invested in the field of wireless charging for related product developments. However, when a user accidentally spills water onto the wireless charging pad during use, a malfunctioning thereof may occur. No significant developments have been made in this aspect for the existing wireless charging pads.

In view of the above mentioned issues, much research has been devoted to the development of wireless charging pads to improve and increase the applications of wireless charging pads.

### SUMMARY OF THE DISCLOSURE

In response to the above-referenced technical inadequacies, the present disclosure provides a wireless charging pad.

In one aspect, the present disclosure provides a wireless charging pad including a substrate, a circuit board, a coil module, and a colloid. The circuit board and the coil module are disposed on the substrate. The circuit board includes a control circuit and a voltage conversion circuit. The control circuit is electrically connected to the voltage conversion circuit and the coil module is electrically connected to the voltage conversion circuit. A colloid encapsulates the substrate, the circuit board and the coil module, and the colloid has a flat appearance.

One of the advantages of the present disclosure is that, through the protection of the encapsulating colloid, the circuit board and the coil module of the wireless charging pad of the present disclosure are unlikely to malfunction from liquid leaking into the wireless charging pad. Therefore, the internal circuit is effectively protected and the service life of the wireless charging pad is extended. The wireless charging pad itself is also flexible by virtue of the use of a soft board, such that storage and carrying of the wireless charging pad in different usage environments is simple and convenient for users. These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1A is a schematic view of one embodiment of the present disclosure.

FIG. 1B is a schematic view of another embodiment of the present disclosure.

FIG. 1C is a schematic view of another embodiment of the present disclosure.

FIG. 1D is a schematic view of another embodiment of the present disclosure.

FIG. 2A is a system block diagram of the wireless charging pad of the present disclosure.

FIG. 2B is another system block diagram of the wireless charging pad of the present disclosure.

FIG. 2C is another system block diagram of the wireless charging pad of the present disclosure.

FIG. 2D is another system block diagram of the wireless charging pad of the present disclosure.

FIG. 3 is a system block diagram of the communication module of the present disclosure.

FIG. 4A is a schematic view of the coil module of the present disclosure.

FIG. 4B is a top view of the coil module of the present disclosure.

FIG. 5A is a schematic view of the configuration position of the wireless charging pad of the present disclosure.

FIG. 5B is another schematic view of the configuration position of the wireless charging pad of the present disclosure.

FIG. 5C is another schematic view of the configuration position of the wireless charging pad of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

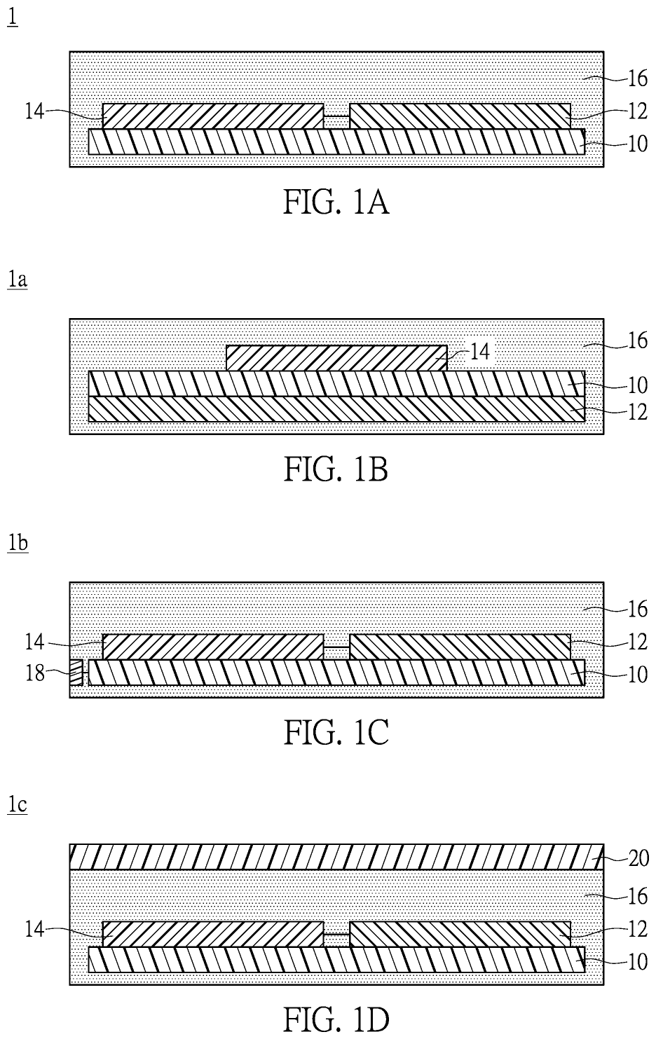

Referring to FIG. 1A, a schematic view of one embodiment of the present disclosure is provided. The structure of the wireless charging pad 1 of the present disclosure mainly includes a substrate 10, a circuit board 12, and a coil module 14. The circuit board 12 and the coil module 14 are disposed on the substrate 10. The circuit board 12 includes a control circuit 121 and a voltage conversion circuit 122. The control circuit 121 is electrically connected to the voltage conversion circuit 122 and the coil module 14 is electrically connected to the voltage conversion circuit 122. A colloid 16 completely encapsulates the substrate 10, the circuit board 12, and the coil module 14, and the colloid 16 has a flat appearance. The upper side of the colloid 16 above the circuit board 12 and the coil module 14 has a first thickness, and the lower side of the colloid 16 below the substrate 10 has a second thickness. The summation of the first thickness and the second thickness is smaller than or equal to 3 mm. The overall thickness of the wireless charging pad 1 is not greater than 5 mm.

### Second Embodiment

Referring to FIG. 1B, a schematic view of another embodiment of the present disclosure is provided. The structure of the wireless charging pad la of the present disclosure mainly includes a substrate 10, a circuit board 12, and a coil module 14. The circuit board 12 and the coil module 14 are disposed respectively on a first side and a second side of the substrate 10 to form a stack of the circuit board 12, the substrate 10, and the coil module 14 sequentially from bottom to top. The circuit board 12 includes a control circuit 121 and a voltage conversion circuit 122. The control circuit 121 is electrically connected to the voltage conversion circuit 122 and the coil module 14 is electrically connected to the voltage conversion circuit 122. A colloid 16 completely encapsulates the substrate 10, the circuit board 12, and the coil module 14, and the colloid 16 has a flat appearance. The upper side of the colloid 16 above the circuit board 12 and the coil module 14 has a first thickness, and the lower side of the colloid 16 below the substrate 10 has a second thickness. The summation of the first thickness and the second thickness is smaller than or equal to 3 mm. The overall thickness of the wireless charging pad la is not greater than 5 mm.

The material of the substrate 10 is one or a combination of paper, leather, wood, cloth, and plastic. The circuit board 12 is a flexible circuit board, e.g., a soft circuit board, which can be stored and easily carried by users. The wireless charging pad la is a soft board, and the colloid 16 is a soft colloid. In one embodiment, the colloid 16 is present only in an area above and to the sides of the circuit board 12 and the coil module 14, and is not present below the substrate 10. The thickness of the colloid 16 is smaller than or equal to 3 mm, and the overall thickness of the wireless charging pad la is not greater than 5 mm, but the present disclosure is not limited to the above mentioned thickness.

### Third Embodiment

Referring to FIG. 1C, a schematic view of another embodiment of the present disclosure is provided. Under the framework of the wireless charging pad 1 of the present disclosure as shown in FIG. 1A and FIG. 1B, the wireless charging pad lb further includes a port 18 that is disposed on the substrate 10 to be connected to an external power 22. The port 18 can be a USB in the standard of USB 3.1, USB 3.0, USB 2.0, USB 1.1, or USB 1.0, and an interface of the port 18 can be a standard USB interface, a Mini-USB interface, or a Micro-USB interface, and the present disclosure is not limited thereto. A colloid 16 encapsulates the substrate 10, the circuit board 12, the coil module 14, and the port 18, and the colloid 16 has a flat appearance. The upper side of the colloid 16 above the circuit board 12 and the coil module 14 has a first thickness, and the lower side of the colloid 16 below the substrate 10 has a second thickness. The summation of the first thickness and the second thickness is smaller than or equal to 3 mm. The overall thickness of the wireless charging pad 1b is not greater than 5 mm.

### Fourth Embodiment

Referring to FIG. 1D, a schematic view of another embodiment of the present disclosure is provided. Under the framework of the wireless charging pad 1 of the present disclosure as shown in FIG. 1A and FIG. 1B, the wireless charging pad 1c further includes a thin film material layer 20 that is disposed on a surface of the colloid 16. The thin film material layer 20 is produced through one of deposition, sputtering, chemical solution deposition (CSD), pulsed laser deposition (PLD), chemical vapor deposition (CVD), and plasma enhanced CVD (PECVD), but the present disclosure is not limited to the above mentioned methods. The thin film material layer 20 increases the smoothness of the wireless charging pad 1c. When the wireless charging pad 1c is a mouse pad, it is convenient for users to slide for a further distance, and the thin film material layer 20 improves the tactile sensation where the palm comes in contact with the mouse pad. A colloid 16 encapsulates the substrate 10, the circuit board 12, the coil module 14, and the port 18, and the colloid 16 has a flat appearance.

The upper side of the colloid 16 above the circuit board 12 and the coil module 14 has a first thickness, and the lower side of the colloid 16 below the substrate 10 has a second thickness. The summation of the first thickness and the second thickness is smaller than or equal to 3 mm. The overall thickness of the wireless charging pad 1c is not greater than 5 mm.

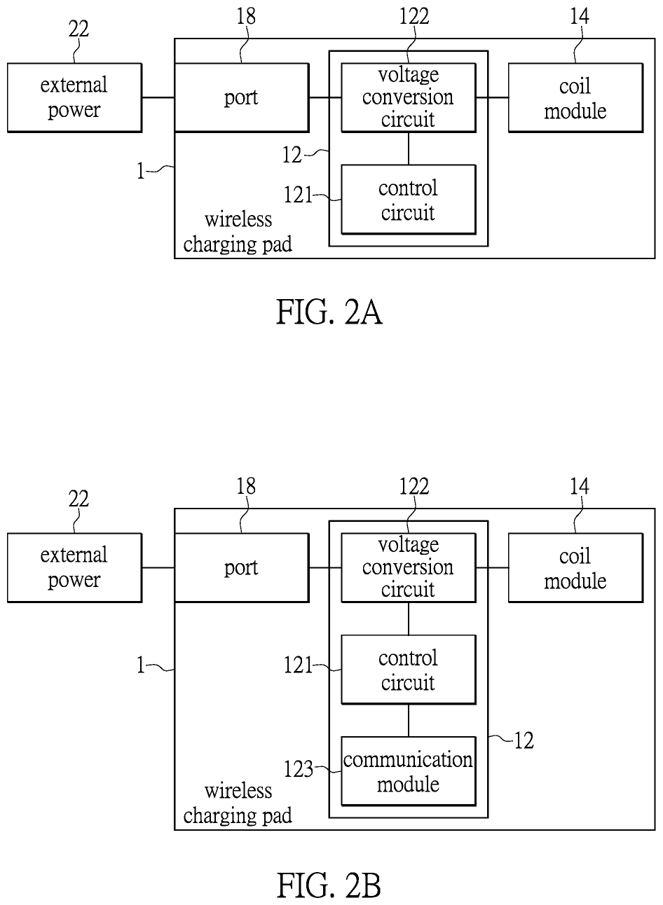

Referring to FIG. 2A, a system block diagram of the wireless charging pad of the present disclosure is provided. The wireless charging pad 1 includes the circuit board 12, the coil module 14, and the port 18. The circuit board 12 includes a control circuit 121 and a voltage conversion circuit 122. The control circuit 121 is electrically connected to the voltage conversion circuit 122 and the coil module 14 is electrically connected to one end of the voltage conversion circuit 122. The other end of the voltage conversion circuit 122 is electrically connected to the port 18, and the voltage conversion circuit 122 is electrically connected to the external power 22 through the port 18. After the external power 22 transmits electricity, e.g., mains electricity, to the voltage conversion circuit 122 through the port 18, the voltage conversion circuit 122 then converts the electricity into electricity with specific power. According to the standards of the Wireless Power Consortium (WPC), the specific power lies between 5 watts to 130 watts. After completing the above mentioned power supply conversion, the control circuit 121 then controls the electricity with specific power to be transmitted to the coil module 14. When an electronic device (not shown in the figures) is disposed on an upper surface of the wireless charging pad 1, the control circuit 121 controls the coil module 14 and the electronic device to generate electromagnetic induction to wirelessly charge the electronic device.

Referring to FIG. 2B, is another system block diagram of the wireless charging pad of the present disclosure is provided. The wireless charging pad 1 includes the circuit board 12, the coil module 14, and the port 18. The circuit board 12 includes the control circuit 121, the voltage conversion circuit 122, and a communication module 123. The communication module 123 is disposed on the substrate 10 and is electrically connected to the control circuit 121. The communication module 123 receives a charging signal of the electronic device, and the control circuit 121 determines the amount of electricity to transmit to the electronic device according to the charging signal. Referring to FIG. 2C and FIG. 2D, another system block diagram of the wireless charging pad of the present disclosure is provided. Under the framework of the wireless charging pad 1 of the present disclosure as shown in FIG. 2A and FIG. 2B, the wireless charging pad 1, as shown in FIG. 2C and FIG. 2D, further includes a battery 24 disposed on the substrate 10 that is electrically connected to the control circuit 121 and the coil module 14. When an induction current is induced by a coil 141 of the coil module 14, the control circuit 121 controls the voltage conversion circuit 122, such that the electricity converted from the induced current is stored in the battery 24.

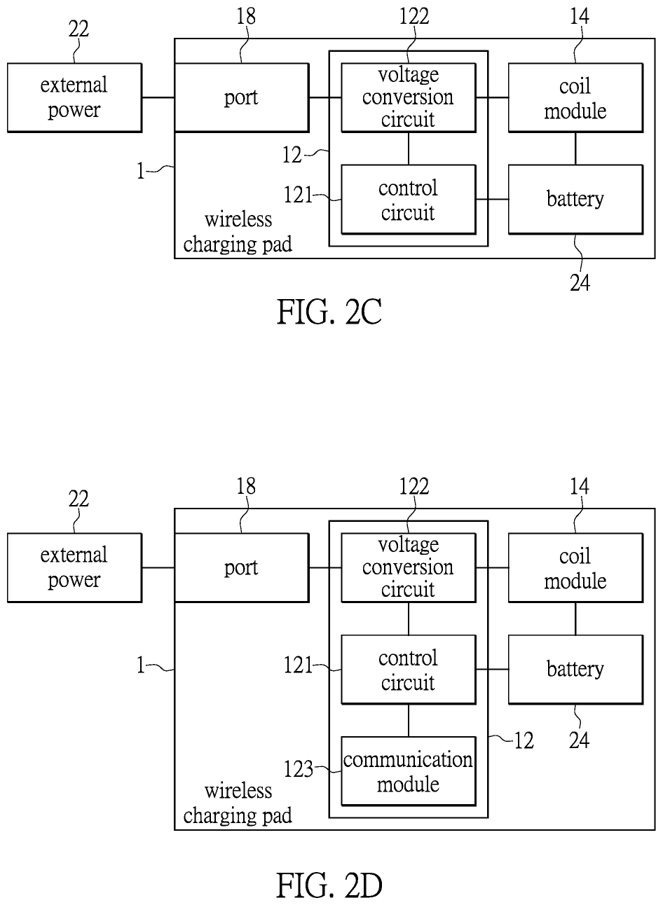

Referring to FIG. 3, a system block diagram of the communication module of the present disclosure is provided. The communication module 123 includes a communication unit 1231 and an antenna unit 1232. The communication unit 1231 can transmit the charging signal to the electronic device to determine whether or not the electronic device requires charging. The antenna unit 1232 can receive the charging signal and then transmits the charging signal to the control circuit 121, such that the control circuit 121 can determine the amount of electricity to transmit to the electronic device according to the charging signal.

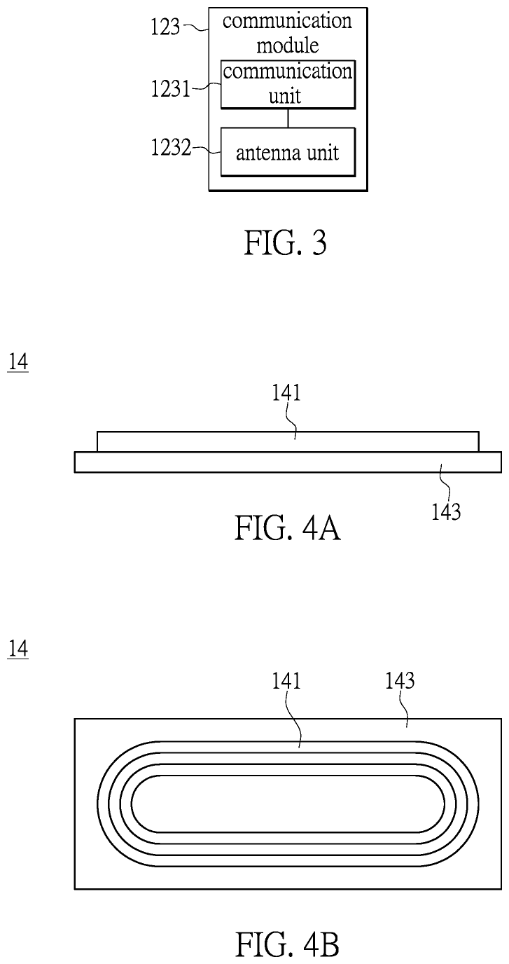

Referring to FIG. 4A and FIG. 4B, a schematic view of the coil module of the present disclosure is provided. The coil module 14 includes the coil 141 and a magnetic permeable board 143. The area of the magnetic permeable board 143 is larger than the area of the coil 141, and the two are stacked upon each other. The coil 141 is one of a single layer coil, a honeycomb coil, a ferrite core, an iron powder core coil, a copper core coil, a color code inducted coil or a deflection coil, and users can choose from the above mentioned types of coils according to their requirements, and the present disclosure is not limited thereto. The magnetic permeable board 143 can enhance the magnetic field of the coil 141, prevent attenuation and interference of metal conductors to the magnetic field, and also prevent energy waste and improve the charging efficiency. The magnetic permeable board 143 is, e.g., a soft magnetic sheet, but the present disclosure is not limited thereto.

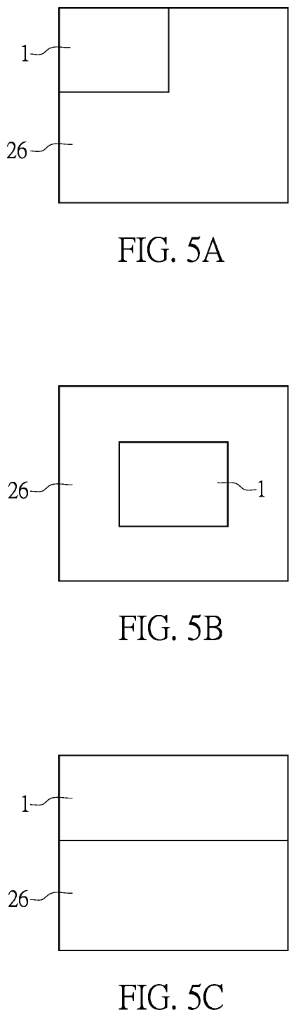

Referring to FIG. 5A to FIG. 5C, a schematic view of the configuration position of the wireless charging pad of the present disclosure is provided. The wireless charging pad 1 further includes a flat substrate 26 that is disposed adjacent to the colloid 16. The flat substrate 26 is a general mouse pad area, which allows users to slide and execute computer programs on. All types of electronic devices, e.g., smart phones, smart watches, wireless headphones, etc., can be placed on the wireless charging pad 1. Through this compound design, users can simultaneously charge the electronic devices while using the mouse, which saves a significant amount of time in application. In FIG. 5A, the wireless charging pad 1 is provided in the upper left area of the flat substrate 26.

In FIG. 5B, the wireless charging pad 1 is provided in the central area of the flat substrate 26. In FIG. 5C, the wireless charging pad 1 is provided in the upper area of the flat substrate 26, therefore, the configuration of the wireless charging pad 1 can be placed in different positions according to the product design, and the present disclosure is not limited thereto.

One of the advantages of the present disclosure is that, through the encapsulating colloid, the wireless charging pad provided by the present disclosure can effectively prevent liquids from leaking into the wireless charging pad and causing malfunctions. In addition, the wireless charging pad is integrally formed, flexible, convenient to store, and also easy for users to carry around.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated.

Alternative embodiments will become apparent to those skilled in the art to which the present disclosure pertains without departing from its spirit and scope.

What is claimed is:

1. A wireless charging pad, comprising:
a substrate;
a circuit board disposed on the substrate, the circuit board including a control circuit and a voltage conversion circuit, wherein the control circuit is electrically connected to the voltage conversion circuit;
a coil module disposed on the substrate and electrically connected to the voltage conversion circuit; and
a colloid, the colloid encapsulating the substrate, the circuit board and the coil module, wherein an appearance of the colloid is flat.

2. The wireless charging pad according to claim 1, wherein the colloid has a thickness, and the thickness is smaller than or equal to 3 mm.

3. The wireless charging pad according to claim 1, wherein the wireless charging pad further includes a port, and the port is disposed on the substrate to be connected to an external power.

4. The wireless charging pad according to claim 1, wherein the circuit board further includes a communication module, and the communication module is disposed on the substrate and electrically connected to the control circuit.

5. The wireless charging pad according to claim 1, wherein the coil module has a coil, a coil substrate, and a magnetic permeable board.

6. The wireless charging pad according to claim 1, wherein the wireless charging pad further includes a battery, the battery is disposed on the substrate and electrically connected to the control circuit and the coil module, and when an induction current is induced by the coil, the control circuit controls the voltage conversion circuit, such that the electricity converted from the induced current is stored in the battery.

7. The wireless charging pad according to claim 1, wherein the wireless charging pad is a soft pad, and the colloid is a soft colloid.

8. The wireless charging pad according to claim 1, wherein the wireless charging pad further includes a thin film material layer disposed on a surface of the colloid.

9. The wireless charging pad according to claim 1, wherein the wireless charging pad is a mouse pad.

10. The wireless charging pad according to claim 1, further including a flat substrate disposed adjacent to a side of the colloid.
